(19) United States
(12) Patent Application Publication
(10) Pub. No.: US 2009/0265309 A1
(43) Pub. Date: Oct. 22, 2009

(54) News Supplying System With a Global Timepiece and the Method Thereof

(76) Inventors: Yoon-hyoung Eo, Seoul (KR); Jang-sung Choi, Suwon (KR)

Correspondence Address: STAAS & HALSEY LLP, SUITE 700, 1201 NEW YORK AVENUE, N.W., WASHINGTON, DC, 20005, US

(21) Appl. No.: 11/988,415

(22) PCT Filed: Jul. 5, 2006
(86) PCT No.: PCT/KR2006/002616

§ 371 Date: Jan. 7, 2008

(30) Foreign Application Priority Data
Jul. 6, 2005 (KR) 10-2005-0060801

(51) Int. Cl. G06F 17/30

(52) U.S. Cl. 707/3; 707/104.1; 707/E17.108; 707/E17.044

(57) ABSTRACT

A news supplying system linked with a global timepiece, which can display a map of an area where news occurs, time and news (information) together. The news supplying system includes: (A) a subscriber information managing part for storing and managing a subscriber's identity information, information on interested region, information on interested field, and so on; (B) a news gathering part for extracting, storing and managing news of the subscriber's interested field; (C) a global timepiece part for creating a global timepiece displaying a world map and time; and (D) a news linking part for linking the extracted and stored news with the global timepiece.

### CROSS-REFERENCE TO RELATED APPLICATIONS

This application claims the benefit of Korean Application No. 10-2005-0060801, filed Jul. 6, 2005, in the Korean Intellectual Property Office, and the PCT Application No. PCT/KR2006/002616, filed Jul. 5, 2006, the disclosure of which is incorporated herein by reference.

### BACKGROUND

1. Field

The present invention relates to a news supplying system linked with a global timepiece, which can display a map of an area where news occurs, time and news (information) together.

2. Description of the Related Art

With rapid development of transportation and communication technologies, opportunities for traveling to various areas all over the world, opportunities for transactions with enterprises in foreign countries, or opportunities for communicating with foreign countries are rapidly increased. Therefore, to quickly obtain news (namely, new information) occurring various areas in the world is an essential factor for winning competitive power to the moderners, particularly, businessmen.

Many business models have been developed and utilized for obtaining new information quickly and conveniently.

Korean Patent Application No. 10-1996-069636 discloses a method for supplying breaking news using an e-mail formed by performing a process including the steps of: storing an index showing the core contents of stored news; storing e-mail service information (including information on interested fields) input by a user; extracting positions of the index and news related with interested information; and reading the news using the position of the news by the user.

In addition, Korean Patent Application No. 10-2000-0033667 discloses system and method for supplying news by section using Internet. The system includes a user terminal, an information media for supplying news, a database for storing news information, and an administrator computer for supplying news to the user terminal after classifying news by section.

Korean Patent Application No. 10-1998-0062740 discloses a method for displaying weather information comprising the steps of: setting time and the number of updates for displaying weather information; requesting weather information to a base station every setting time; and displaying received weather information.

Korean Patent Application No. 10-2000-0005312 discloses a method for supplying news at real time through Internet comprising the steps of: connecting a news server with computers of expression organs of each region so as to transfer news of a relevant region from the computer of the expression organ to the news server; and gathering news of each region transferred to the news server and supplying the gathered news at real time through Internet news sites.

Korean Patent Application No. 10-2000-0048382 discloses a method for supplying security information and news, that a client sets kinds and an indication type of information. The system includes a number of security information supplying sites and a number of news supplying sites, a service server for gathering and transmitting information requested by the client from the sites, and the client.

Korean Patent Application No. 10-2002-0026734 discloses customized information supplying system by a wireless communication system. The system for supplying customized information includes: a service information database for storing user information and news data; a service supplying server for supplying corresponding news according to user qualification and news selection; and a user incentive providing system.

The above-mentioned prior arts just disclose methods/systems including the steps: \textcircled{1} referring information on a user's interested field; \textcircled{2} gathering news (new information; news, weather information, security information, and so on); and \textcircled{3} transmitting the gathered information to a user, or methods/systems including the steps: \textcircled{1} gathering news and indexing or sectioning the news; \textcircled{2} displaying the news; and \textcircled{3} providing news selected by the user in detail.

News (new information) must basically include 3 data at least such as; \textcircled{1} the place of origin of the news, \textcircled{2} the time when the news has been made (occurrence time of news belongs to contents information), and \textcircled{3} contents information. News supplied by the prior arts includes the above-mentioned three data, however the information on the place of origin of the news is contained in the contents information, and so, has a problem in that the user only can know the place of origin of the news when he or she reads contents information. In addition, news supplied by the prior arts is supplied in letters and in plane, and so, has another problem in that it is difficult to intuitively judge whether or not the information is information necessary to the user.

Therefore, a system of a new method which enables a user to correctly and quickly accept information meaningful to the user, out of a great deal of quickly occurring and disappeared information, by utilizing information on the place of origin of news, information on the time when the news occurred, and field information on news recognized through a human being's sense of local space (that is, not a “name of region” expressed in letters but a sense for grasping time information expressed by “position” on a map) and sense of time (natural sense of time according to the earth's revolution and rotation) has been required.

### SUMMARY

Additional aspects and/or advantages will be set forth in part in the description which follows and, in part, will be apparent from the description, or may be learned by practice of the invention.

Accordingly, it is an object of the present invention to provide a news supplying system linked with a global timepiece, which enables a user to instantly and synesthetically grasp the local time of all regions in the world and geographical environments at the time.

□Technical Solution□

To achieve the above objects, the present invention provides a news supplying system linked with a global timepiece includes: (A) a subscriber information managing part for storing and managing information on a subscriber's identity, information on interested region, information on interested field, and so on; (B) a news gathering part for extracting, storing and managing news of the subscriber's interested field; (C) a global timepiece part for creating a global timepiece displaying a world map and time; and (D) a news linking part for linking the extracted and stored news with the global timepiece.

In the present invention, news contains information of all kinds including issues of the day. For instance, news contains information broadcasting at news time through a television set or a radio set or information printed on newspaper, and information recently supplied through real time information supplying sites on the Internet. Here, the “issues of the day” means not only the recent information but also the past information related with the present or recent information.

The news supplying system according to the present invention can be applied to cases where a subscription procedure and a connection procedure through input of member ID and password, which are conducted in common Internet websites, are needed, since the system supplies news corresponding to the subscriber's interested information. However, supposing that a virtual subscriber is interested in all fields in a wide sense, this system may be a news supplying system linked with a global timepiece, which is not connected according to a “membership system” but is connected as a user pleases.

□Advantageous Effects□

The present invention enables the user to instantly and synesthetically grasp the local time of all regions in the world and geographical environments at the time, so that the user can correctly and quickly accept information meaningful to the user, out of a great deal of information by utilizing information on the place of origin of news, information on the time when the news occurred and field information on news recognized through a human being's senses of space and time.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a conceptual view showing a configuration and external parts of a news supplying system linked with a global timepiece according to the present invention.

FIG. 2 is a view showing an example of an electronic global timepiece used in the present invention.

FIG. 3 is a conceptual view showing internal parts of news connected with the global timepiece used in the present invention.

FIGS. 4 and 5 are views showing an example of a process that news connected with the global timepiece used in the present invention is displayed.

FIG. 6 is a flow chart showing an operation of the news supplying system with the global timepiece according to the present invention.

### EXPLANATION ON REFERENCE NUMERALS OF ESSENTIAL PARTS

10 . . . inner plate

11 . . . world map of hemisphere

12 . . . date line

20 . . . standard hour display portion

30 . . . outer plate

31 . . . time scale

40 . . . hour hand

41 . . . minute hand

42 . . . second hand

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

The present invention relates to a news supplying system linked with a global timepiece includes: (A) a subscriber information managing part for storing and managing information on a subscriber's identity, information on interested region, information on interested field, and so on; (B) a news gathering part for extracting, storing and managing news of the subscriber's interested field; (C) a global timepiece part for creating a global timepiece displaying a world map and time; and (D) a news linking part for linking the extracted and stored news with the global timepiece.

Reference will now be made in detail to the preferred embodiments of the present invention, examples of which are illustrated in the accompanying drawings.

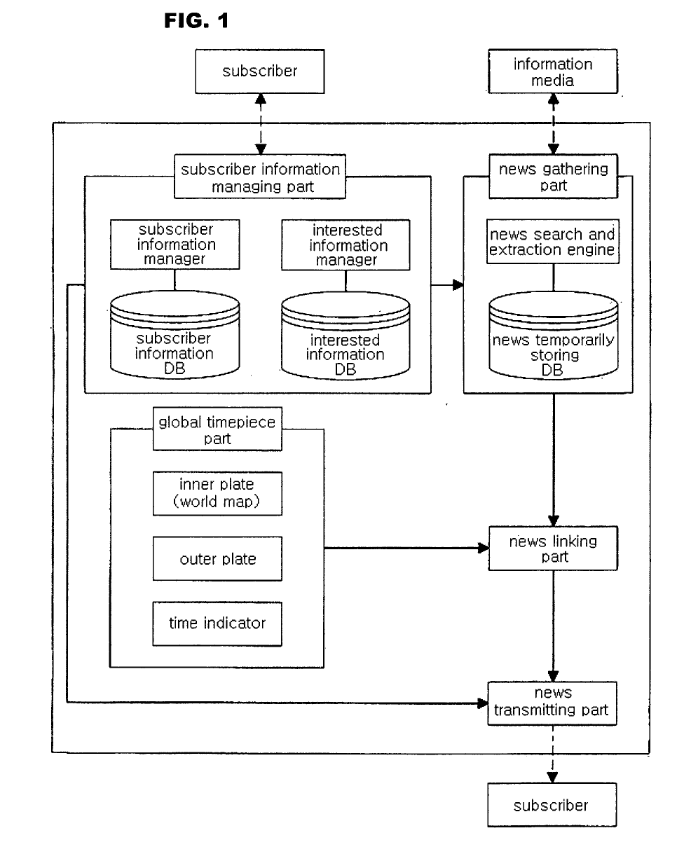

FIG. 1 is a conceptual view showing a configuration and external parts (a user terminal and an information medium) of a news supplying system linked with a global timepiece according to the present invention. As you can see from the drawing, the news supplying system with the global timepiece according to the present invention includes the subscriber information managing part, the news gathering part, the global timepiece part, and the news linking part.

(A) The subscriber information managing part includes a subscriber information manager, an interested information manager, a subscriber information DB, and an interested information DB. The subscriber information manager stores and manages at least identity information (ID and password) for confirming whether or not the subscriber has a right to connect to service supplying sites of the present invention and information on news receiving place, such as IP address or e-mail address, necessary for transmitting news to the subscriber's wanted address when the subscriber wants transfer of the news to the wanted address without reading the news on the service supplying website in the subscriber information DB, and confirms whether or not the subscriber is a member. In the news-receiving place, IP address contains IP address of a terminal that the subscriber connects to the Internet now. The interested information manager stores and manages at least information on regions and fields in which the subscriber is interested.

The identity information may contain not only ID and password but also information generally demanded by the websites, for instance, the subscriber's name, resident registration number, address, phone number, birth date, family relationship, and so on, and is not restricted to the above.

The “interested region” may mean a country, a wide area or a subdivided administrative district of a specific country (for example, America, a state of America, a county of a state of America, Korea, a city of Korea, Gun of a city of Korea, and so on), or a main city of the world. A method for making a subscriber select a geographical region indicated in a stratiform type has been widely known, and so, its detailed description will be omitted. The subscriber can designate one or more interested region, or if necessary, designate all regions all over the world.

Additionally, a classification method, an indication method, and a selection method of information on the interested fields have been widely known, and so, they can be utilized. The subscriber can select at least one of various interested fields, for instance, politics, economics, culture, science, society, environment, law, entertainment, sports, amusement, and so on. In the meantime, the subscriber may receive individualized news information by registering a keyword in person without following the classification standard provided by the website of the present invention.

In this invention, the subscriber information and information on interested field may be stored temporarily or for a long time. That is, in the case where it is prescribed to provide the subscriber with this system one time, information on the subscriber's identity, news receiving place, interested regions and interested fields are all disappeared when the subscriber's connection is terminated after being temporarily stored in the subscriber information DB and the interested information DB. However, in the case where the system of the present invention is managed by the membership system like the common websites, it is preferable that information on the subscriber's identity, news receiving place, interested regions and interested fields is stored in the subscriber information DB and the interested information DB for a long time and amended whenever there are any changed matters.

In the present invention, the subscriber information manager, the interested information manager, the subscriber information DB and the interested information DB are classified conceptually, but may be integrated into one manager and one DB.

(B) In the present invention, the news gathering part includes a news search and extraction engine and a news temporarily storing DB. The news search and extraction engine extracts news corresponding to a specific subscriber's interested field from various information media by referring the interested information DB, and stores and manages Meta information on the extracted news (at least, address of the news on the Internet, region where the news occurred, time when the news occurred, information on relevant field of the news) and/or contents information (contents containing a title of the news) in the specific subscriber's news temporarily storing DB. Meta information contains link information on the source of news, and so, it is possible that a user can click Meta information to directly connect to the source of news (website), if necessary.

Various methods for searching and extracting information on the Internet have been well known. For instance, the news search and extraction engine in the present invention may be a real time information search robot and its management program. The information search robot searches, extracts and gathers news of the specific subscriber's interested field from information media on the Internet (including contents providers in a wide sense and all sites on the Internet), and stores it in the specific subscriber's news temporarily storing DB. The news search and extraction engine may further include a list DB of information media.

(C) Differently from the prior art news supplying systems, the present invention essentially includes the global timepiece part for creating the electronic global timepiece. The electronic global timepiece is a “programmed” electronic timepiece including: an inner plate displaying a world map of the Southern or Northern hemisphere, the world map having the South Pole or the North Pole placed at the center thereof and having a date line and day-and-night described thereon, the inner plate turning around once a day in the same direction as the revolution of the earth; an outer plate having scales divided at uniform angles on the center thereof for indicating time; and a time indicator turning around once a day for indicating time. Each region on the world map of the electronic timepiece is divided into areas or points (hereinafter, called “area” if there is no a special comment) according to various stratiform phases (by country, state, subdivided administrative district, city, and others) if necessary, and each area is indexed to be linked with the name of the relevant “interested region”.

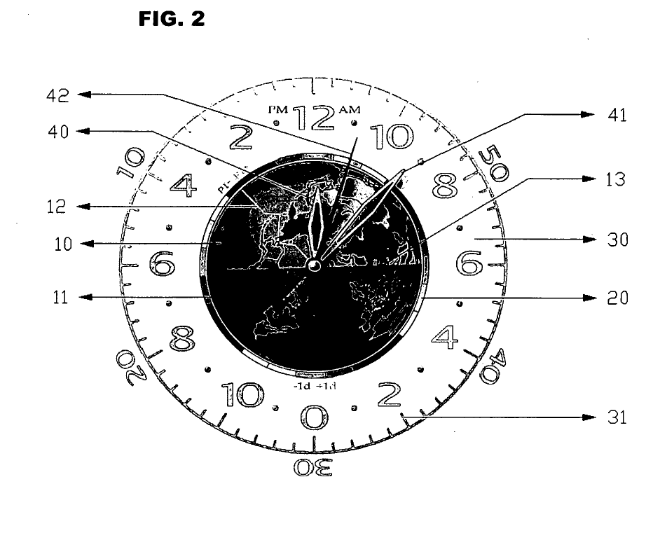

The electronic global timepiece may further include a minute hand turning around once an hour, and a second hand turning around once a minute. FIG. 2 shows an example of the electronic global timepiece used in the present invention.

Meanwhile, the electronic global timepiece in the present invention further includes a standard hour display portion divided at uniform angles on the center of the inner plate, indicated in different colors according to the standard hour, and turning around once a day in the same direction as the revolution of the earth, and it is also possible that regions on the world map of the inner plate are divided with colors corresponding to the standard hours of the standard hour display portion. The local time where the subscriber is can be automatically settled by referring to time display function of subscriber's terminal.

In addition, the electronic global timepiece is minutely disclosed in Korean Patent Application No. 10-2005-30249 (entitled “universal timepiece which can display day-and-night”) invented by the same inventors of the present invention.

(D) The news linking part links Meta information and/or contents information on news stored in the specific subscriber's news temporarily storing DB to an area of the world map of the global timepiece, which corresponds to the news occurred region, and creates global timepiece-linked news. A method for linking a specific part of an image and specific information has been utilized in the prior arts in various ways, and so, its detailed description will be omitted.

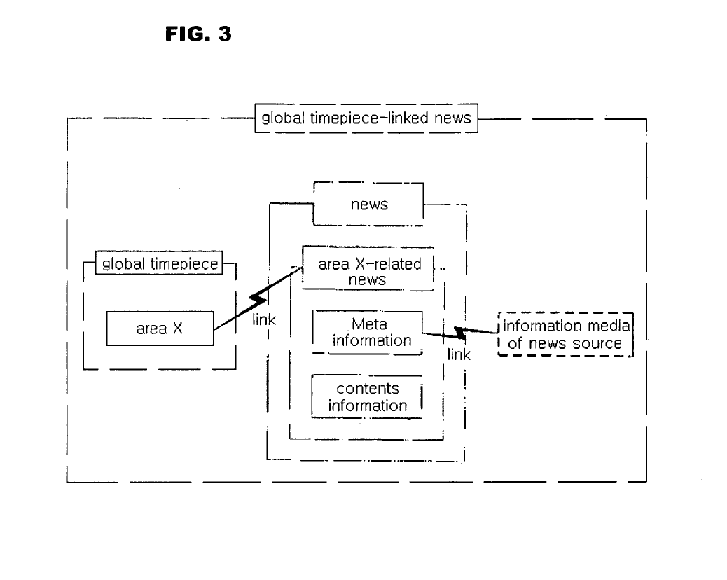

The global timepiece-linked news created by the operation of the news linking part has, for instance, a data connection structure shown in FIG. 3. That is, each area (area X) of the global timepiece is linked with area X related news, and Meta information on gathered news is linked with the information media, which are the source of the gathered news.

(E) The news supplying system according to the present invention can further include a news transmitting part, and the news transmitting part serves to transfer the global timepiece-linked news to the specific subscriber's news receiving place, for instance, the designated IP address or e-mail address, by referring information on news receiving place stored in the subscriber information DB.

The global timepiece-linked news transferred to the specific subscriber may be displayed on the web browser such as Explorer, or displayed by a separate operation program.

A method for displaying the global timepiece-linked news may be selected in various ways utilizing the prior arts as occasion demands. For instance, there are □ a method of always displaying the global timepiece and news on one browser frame, □ a method of displaying a corresponding news list in a tool tip form when a cursor approaches or points the area X in a state where only the global timepiece is displayed, and □ a method of displaying the entire relevant news or a list of the relevant news on a new window or frame when the cursor clicks the area X in a state where only the global timepiece is displayed. However, the method for displaying the global timepiece-linked news is not restricted to the above.

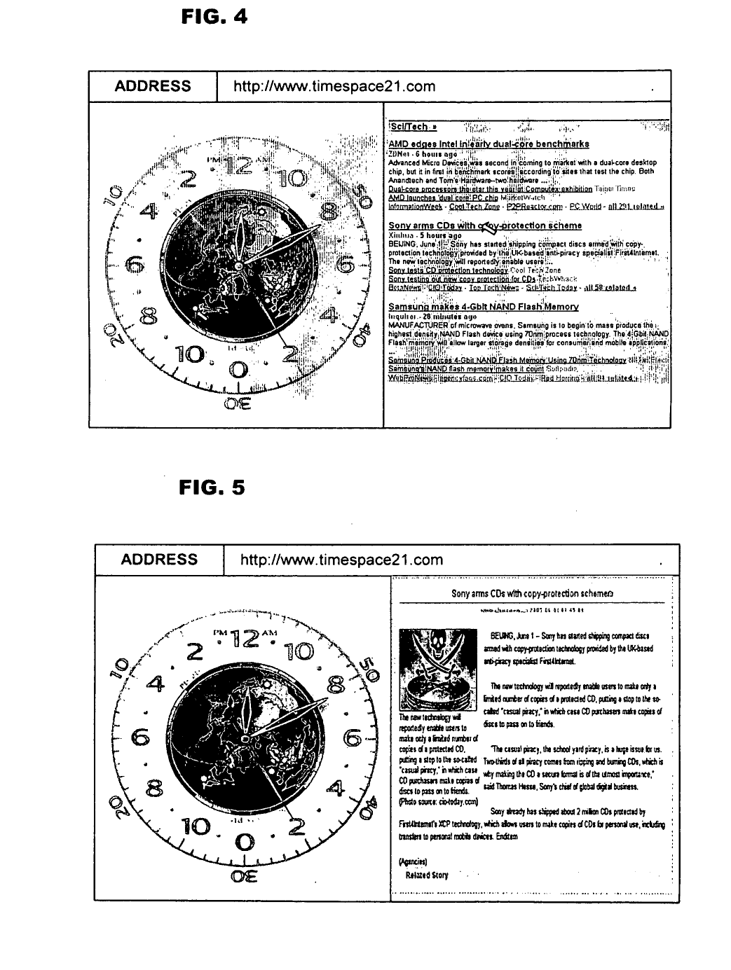

FIGS. 4 and 5 show examples of processes for displaying the global timepiece-linked news. Screens shown in FIGS. 4 and 5 are displayed on the subscriber who previously inputted and stored the interested region and field. FIGS. 4 and 5 show a website form divided into two frames, but other types may be applied to the present invention.

In FIGS. 4 and 5, the (virtual) subscriber's interested regions are at least United States (or Washington), China (or Beijing), England (or London), India (New Deli), and other regions (for instance, Japan (Tokyo)), and interested fields are science, technology, and other fields. According to an operation process of the news supplying system linked with a global timepiece of the present invention, which will be described later, the system informs that news of the interested fields have been occurred in United States, China and England among the subscriber's interested regions by showing a specific indication (star marks in FIGS. 4 and 5) on the corresponding regions of the electronic global timepiece. When the subscriber (connector) puts the cursor on the United States mark on the world map and clicks the mark, news occurring in United States is displayed on another frame (news indication frame). After that, when the subscriber selects and clicks one of the news (FIG. 4), the entire news is displayed on the news indication frame in more detailed (FIG. 5). The subscriber can obtain news of interested fields of other regions at any time by clicking other indicated regions on the world map.

To enhance readability, it is also possible to change colors of the area or periodically turning over the area according to kinds of the interested fields when news of the interested fields are searched in the subscriber's interested regions. For instance, in the case where it is designated that politics news is twinkled in red color and sports news is twinkled in blue color, the corresponding area is twinkled in red color when politics news occurs in the interested region, and the area is periodically twinkled in red and blue colors when the politics news and the sports news occur simultaneously.

Therefore, when the specific subscriber clicks the area X on the world map of the global timepiece, news (or Meta information on the news) related with the linked area X is displayed, and when the specific subscriber clicks Meta information on the news (for instance, address of website which is the source of the news), contents information on the news or a relevant data window of the linked website is displayed.

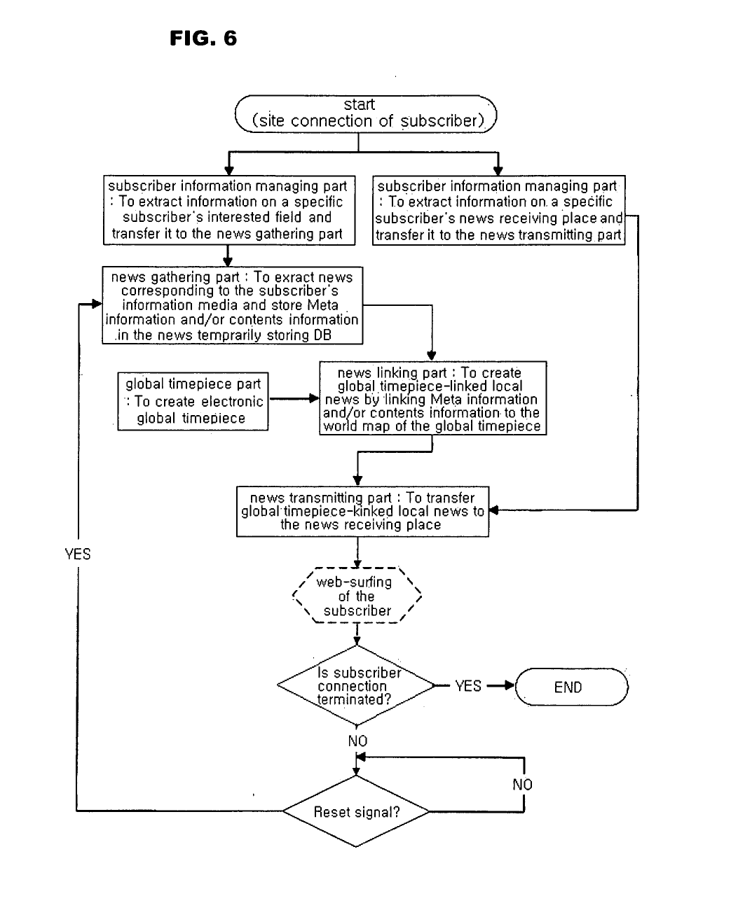

Referring to the drawings, the operation process of the news supplying system with the global timepiece will be described in detail. FIG. 6 is a flow chart showing the operation of the news supplying system with the global timepiece according to the present invention.

First, the system starts to work when the subscriber connects to the news supplying system according to the present invention (it may be a ‘website on the Internet’ and hereinafter, called ‘this system’). Of course, if necessary, the subscriber may go through a subscription procedure and a connection procedure through input of member ID and password, which are conducted in common Internet websites. In addition, information on the subscriber's interested regions, fields, and others is previously stored in the subscriber information DB and the interested information DB. When the subscriber connects to this system, the subscriber information managing part extracts the subscriber (connector)'s interested fields through the subscriber information manager-subscriber information DB and the interested information manager-interested information DB and transfers them to the news gathering part, and extracts information on the subscriber's news receiving place and transfers it to the news transmitting part.

The news gathering part received information on the subscriber's interested fields from the subscriber information managing part searches various information media through one of various existing methods, extracts news corresponding to the subscriber's interested fields, and stores Meta information and/or contents information on the news in the news temporarily storing DB.

Meanwhile, the global timepiece part creates the electronic global timepiece where regions on the world map are divided into areas or points according to various stratiform phases and each area is indexed to be linked with the name of the relevant “interested region” and transfers it to the news linking part.

Continuously, the news linking part receives Meta information and/or contents information on the stored news from the news gathering part, and creates global timepiece-linked local news by linking the information to the world map of the electronic global timepiece.

The created global timepiece-linked local news is. transferred to the news transmitting part, and the news transmitting part transfers it to the subscriber by referring information on the subscriber's news receiving place received from the subscriber information managing part. So, the global timepiece-linked local news is displayed on the connected subscriber's terminal, and the subscriber can read (or listen) the news while web surfing by clicking the global timepiece-linked local news displayed on the subscriber's terminal according to the subscriber's taste.

If connection between the subscriber's terminal and this system were interrupted due to the subscriber's mistake or a network error after or during the above process, it would be appreciated that the process according to the present invention will be terminated. Moreover, when the subscriber uses a ‘Reload’ function during connection, new information is gathered (through the same process as the above), and then, updated global timepiece-linked local news is displayed on the subscriber's terminal.

Through the above-mentioned process, the subscriber can easily search news of the interested fields in the interested region.

### INDUSTRIAL APPLICABILITY

As described above, the news supplying system of the new method according to the present invention enables the user to naturally recognize the local time of every region in the world, where the user (subscriber) is interested, according to the subscriber's natural sense of time by the earth's revolution and rotation. Additionally, the news supplying system according to the present invention enables the user to instantly grasp through “positions” on the world map not letters whether or not news of the interested fields occurs in the interested region. Therefore, the user can correctly and quickly accept information meaningful to the user, out of a great deal of information, by utilizing information on the place of origin of news, information on the time when the news has been made, and field information on news recognized through a human being's senses of time and space.

Although a few embodiments have been shown and described, it would be appreciated by those skilled in the art that changes may be made in these embodiments without departing from the principles and spirit of the invention, the scope of which is defined in the claims and their equivalents.

1. A news supplying system linked with a global timepiece comprising:
(A) a subscriber information managing part including; a subscriber information manager for storing and managing at least information on a subscriber's identity and, if necessary, information on news receiving place in a subscriber information DB to identify the subscriber, and an interested information manager for storing and managing at least information on the subscriber's interested regions and fields in an interested information DB;
(B) a news gathering part including; a news search and extraction engine for extracting news corresponding to a specific subscriber's interested field from various information media by referring the above interested information DB, and storing and managing Meta information and/or contents information on the extracted news in the specific subscriber's news temporarily storing DB;
(C) a global timepiece part for creating an electronic global timepiece including: an inner plate displaying a world map of the Southern or Northern hemisphere, the world map having the South Pole or the North Pole placed at the center thereof and having a date line and day-and-night described thereon, the inner plate turning around once a day in the same direction as the revolution of the earth; an outer plate having scales divided at uniform angles on the center thereof for indicating time; and a time indicator turning around once a day for indicating time;
(D) a news linking part for creating global timepiece-linked news by linking the Meta information and/or contents information on the specific subscriber's news temporarily storing DB to the world map of the global timepiece on which a region where the news occurred is described; and
(E) a news transmitting part for transmitting the global timepiece-linked news to the specific subscriber's news receiving place by referring information on the subscriber's news receiving place stored in the subscriber information DB.

2. The news supplying system according to claim 1, wherein information on the subscriber's identity, news receiving place, interested region and interested field is stored and managed in the subscriber information DB and the interested information DB for a long time.

3. The news supplying system according to claim 1, wherein information on the subscriber's identity, news receiving place, interested region and interested field is temporarily stored and managed in the subscriber information DB and the interested information DB, and then disappeared when the subscriber's connection is terminated.

4. The news supplying system according to claim 1, wherein Meta information includes link information on the source of news.

5. The news supplying system according to claim 1, wherein the news search and extraction engine consists of a list DB of information media and a real time information search robot.

6. A news supplying system linked with a global timepiece comprising:
a subscriber information managing part including; a subscriber information manager for storing at least information on a subscriber's identity and, an interested information manager for storing at least information on the subscriber's interested regions and/or fields in an interested information DB;
a news gathering part including; a news search and extraction engine for extracting news corresponding to the subscriber's interested field from various information media by referring the interested information DB, and storing Meta information and/or contents information on the extracted news in the subscriber's news temporarily storing DB;
a global timepiece part for creating an electronic global timepiece;
a news linking part for creating global timepiece-linked news by linking the Meta information and/or contents information on the subscriber's news temporarily storing DB to the global timepiece on which a region where the news occurred is described; and
a news transmitting part for transmitting the global timepiece-linked news to the subscriber.

7. The news supplying system according to claim 6, wherein information on the subscriber's identity, news receiving place, interested region and/or interested field is stored and managed in the subscriber information DB and the interested information DB.

8. The news supplying system according to claim 6, wherein Meta information includes link information on the source of news.

9. The news supplying system according to claim 6, wherein the news search and extraction engine comprises:
a list DB of information media and/or a real time information search robot.

10. The news supplying system according to claim 6, wherein the global timepiece comprises:
an inner plate displaying a world map of the Southern or Northern hemisphere, the world map having the South Pole or the North Pole placed at the center thereof and having a date line and day-and-night described thereon, the inner plate turning around once a day in the same direction as the revolution of the earth; an outer plate having scales divided at uniform angles on the center thereof for indicating time; and a time indicator turning around once a day for indicating time.

11. The news supplying system according to claim 6, wherein the subscriber information DB and/or the interested information DB are deleted when the subscriber's connection is terminated.

12. A method of supplying a news with a global timepiece comprising:
searching a news and extracting the news corresponding to a subscriber's interested field from various information media by referring the interested field, and storing meta information and/or contents information on the extracted news;
linking global timepiece-linked news by linking the Meta information and/or contents information on the subscriber's news DB to the global timepiece on which a region where the news occurred is described; and
transmitting for transmitting the global timepiece-linked news to the subscriber.

13. The transmitting method of claim 12, wherein the global timepiece comprises:
an inner plate displaying a world map of the Southern or Northern hemisphere, the world map having the South Pole or the North Pole placed at the center thereof and having a date line and day-and-night described thereon, the inner plate turning around once a day in the same direction as the revolution of the earth; an outer plate having scales divided at uniform angles on the center thereof for indicating time; and a time indicator turning around once a day for indicating time.

14. The method of claim 12, further comprises information on the subscriber's identity, news receiving place, interested region and/or interested field is stored and managed in a subscriber information DB and the interested information DB.

15. The method of claim 12, wherein information on the subscriber's identity, news receiving place, interested region and interested field is temporarily stored and managed in the subscriber information DB and the interested information DB, and then deleted when the subscriber's connection is terminated.

16. The method of claim 12, wherein Meta information includes link information on the source of news.

17. The method of claim 12, wherein the news search and extraction engine comprises a list DB of information media and a real time information search robot.
